(19) United States
(12) Patent Application Publication
(10) Pub. No.: US 2003/0165130 A1
(43) Pub. Date: Sep. 4, 2003

(54) Host extensible wireless application interface

(75) Inventors: Richard Wodzianek, Coquitlam (CA); Parampreet Sandhu, Surrey (CA)

Correspondence Address: Robert E. Krebs, Thelen Reid & Priest LLP, P. O. Box 640640, San Jose, CA, 95164-0640, US

(73) Assignee: Sierra Wireless, Inc., a Canada Corporation

(21) Appl. No.: 10/342,166

(22) Filed: Jan. 13, 2003

Related U.S. Application Data
(60) Provisional application No. 60/346,917, filed on Jan. 11, 2002.

(51) Int. Cl. H04Q 7/24

(52) U.S. Cl. 370/338; 370/342

(57) ABSTRACT

A host extensible wireless application interface is disclosed. The interface is run on a host device connected to a wireless device. The interface permits applications for the wireless device to be executed by the host device. Accordingly, the application interface allows functions that are specific for the wireless application to be processed by the host device and executed by the wireless device.

### CROSS-REFERENCE TO RELATED APPLICATION

This application claims priority based on provisional application serial No. 60/346,917 [Dkt. No. 034300-170], entitled “HOST EXTENSIBLE WIRELESS APPLICATION INTERFACE” by Richard Wodzianek and Parampreet Sandhu filed on Jan. 11, 2002.

### BACKGROUND OF THE INVENTION

1. Field of Invention

The present invention generally relates to wireless devices and more particularly to a runtime environment for the wireless device that executes applications on a host device.

2. Status of the Prior Art

Application development environments have been designed to allow application developers to exploit the internal functions of wireless devices. Accordingly, API's (application programmer's interface) allow developers to design applications that access internal functions of wireless devices such as GPS, Bluetooth, WAP browser, Instant Messaging, multimedia, games, etc . . . of a wireless device. An example of an application development environment is the Binary Runtime Environment for Wireless (BREW) created by Qualcomm. The BREW API is an object-oriented platform supporting simple application execution on mobile devices that decouples applications from wireless device specific events.

The BREW API is an applications platform for wireless devices that is a very thin, standardized platform which supports application development for the large and growing CDMA handset market. Accordingly, the BREW API can support inexpensive, mass-market phones through high-end, multi-purpose wireless devices. The BREW API provides a familiar development environment for applications developers that protects essential operations of phones and wireless networks. Furthermore, the BREW API enables rapid development of a wide variety of downloadable applications. Currently, the BREW API is available only on CDMA handset products such as cellular phones. Because it is not an operating system, but a set of libraries that form an API, the BREW API is dependent upon the underlying CDMA platform.

The BREW API operates within the “smartphone” paradigm and runs on top of a MSP (Mobile Station Processor) and MSM (Mobile Station Modem) of the wireless device. Referring to FIG. 1, the handset platform 10 for a mobile device is shown. The handset platform 10 supports a BREW application 12 on the top layer. The BREW application 12 is created by the application developer and can be run by the wireless handset. For instance, the BREW application may be a sound player, map viewer, game, or any type of application that takes advantage of the features of the wireless device. The BREW applications 12 run on top of the BREW API 14, as seen in FIG. 1. The BREW API 14 is part of the runtime environment available in CDMA based wireless handsets. BREW API 14 runs on the CDMA mobile station modem chipset which includes the MSM and MSP.

Referring to FIG. 2, the handset platform 10 is shown in greater detail. The platform 10 includes BREW applications 12 which run on top of the BREW API 14 and OEM UI applications 18. The BREW API 14 interacts with an OEM user interface 20 and handset specific modules 22 such as sockets, EFS, call managers and wireless Internet launchpad. In the same layer as the handset specific modules 22 are OEM drivers 24 for the handset. As seen in FIG. 2, wireless handset specific modules 22 or features are made available to application 12 via the BREW API 14.

Often times, the mobile device such as a PDA or laptop computer will contain a wireless device such as a CDMA wireless modem. In this regard, the mobile device (i.e., PDA) will not run the handset platform 10 previously described. Typically, the mobile device will run it's own platform. For example if the mobile device is a PDA, then the device will use Microsoft's PocketPC operating system using PC Card and embedded module form factors. BREW applications 12 designed to be run utilizing the BREW API 14 run on the handset platform 10 will not function properly on the mobile device. The BREW applications 12 will not function on mobile devices that have wireless capability because the devices do not run the mobile handset platform 10 as previously described. Accordingly, PDA's and laptops that have wireless capabilities will not be able to utilize BREW applications 12.

The present invention addresses the above-mentioned deficiencies in the current architecture for mobile devices by providing a host extensible wireless application interface that is run by the host of the wireless device. The present invention provides a system and method for providing a way to run the BREW API 14 on a mobile device even though the mobile device does not utilize the handset platform 10. Accordingly, the present invention provides a system and method for a mobile device to run BREW applications 12 without utilizing a handset platform.

### SUMMARY OF THE INVENTION

In accordance with the present invention, there is provided a system and method to run applications created for the Binary Runtime Environment for Wireless (BREW) on a host operating system of a mobile device. The present invention provides a BREW API translation layer which allows native BREW applications to run on a host specific operating system rather than a wireless handset platform operating system. The translation layer provides a method for the BREW application to access commands of the wireless device, even though the wireless device is not running a wireless handset platform. This is extremely advantageous when the wireless device is a wireless modem card inserted into a PDA. The BREW applications can then be seamlessly run on the PDA while utilizing the functions of the wireless modem. The translation layer further provides a method for extending the functionality of the BREW application.

### BRIEF DESCRIPTION OF THE DRAWINGS

These as well as other features of the present invention will become more apparent upon reference to the drawings wherein:

FIG. 1 illustrates a handset platform architecture for a binary runtime environment for a wireless device;

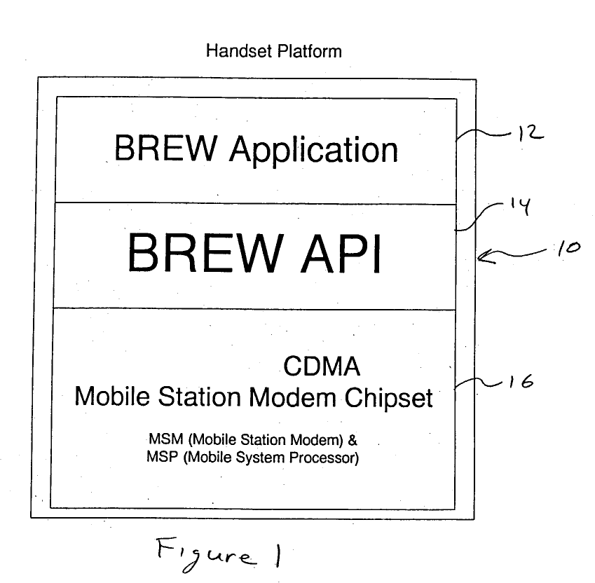

FIG. 2 illustrates the architecture of FIG. 1 in greater detail;

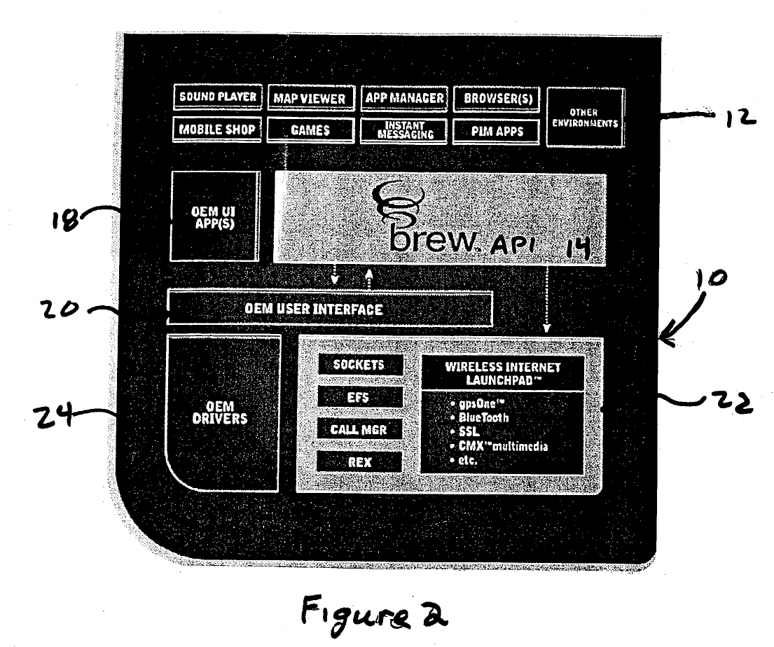

FIG. 3 illustrates the architecture of a system utilizing a wireless device such as a CDMA device but not having a handset platform; and

FIG. 4 is a flow diagram showing how translation occurs in the present invention.

### DETAILED DESCRIPTION OF THE PREFERRED EMBODIMENT

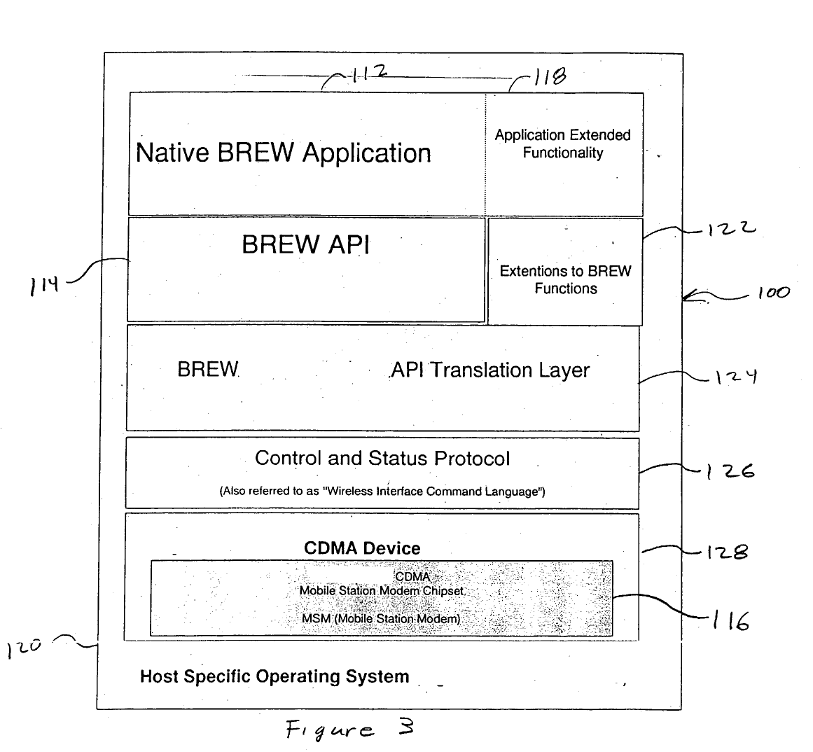

Referring now to the drawings wherein the showings are for purposes of illustrating a preferred embodiment of the present invention only, and not for purposes of limiting the same, FIG. 3 illustrates an architecture 100 for a mobile device having a host specific operating system 120 that is not a handset platform. For example, the host specific operating system 120 may be Microsoft's PocketPC that is run on PDA's. Referring to FIG. 3, native BREW applications 112 and applications that extend functionality 118 run on the top layer within the host specific operating system 120. As previously mentioned, BREW applications 112 are programs designed to be run on a wireless handset device. The applications that extend functionality are programs which take advantage of the unique operating features of a device and are not generic to BREW applications 112. For instance applications can take advantage of enhanced wireless capabilities specific to certain CDMA devices (i.e., IS-95A/B, 1xRTT, 1xEVDO), GPRS and UMTS implementations.

Below the BREW Application 112 is the BREW PI 114 which operates on the BREW applications 112, as previously discussed. Furthermore, in this layer are extensions to BREW functions 122 which operate on the extended applications 118. Accordingly, the BREW API 114 and the extensions to BREW functions 122 are operative to run the respective native BREW applications 112 and functionally extended applications 118.

In order to translate the commands from the BREW API 112 for use by the host specific operating system, the architecture 100 further includes a BREW API translation layer 124 below the BREW API 114, as seen in FIG. 3. During operation, native BREW applications 112 call functions specified in the BREW API 114 which is a reference library. The BREW API translation layer 124 will accept the binary format of the function call from the BREW API 114 and perform the appropriate translation of function and parameters. The translated functions and parameters will then be sent to a control and status protocol layer 126 that monitors and controls the operation of a CDMA device 128. The translated function calls are then sent to the CDMA device 128 for execution by the CDMA mobile station modem chipset 116. As previously mentioned above, the CDMA device 128 may not be a wireless handset but may be a wireless modem that utilizes the host specific operating system 120 for operation. The BREW API translation layer 124 performs the necessary translation of commands such that BREW applications can be executed by the CDMA device 128. Furthermore, the BREW API translation layer 124 can translate commands from the CDMA device 128 to the BREW application 112.

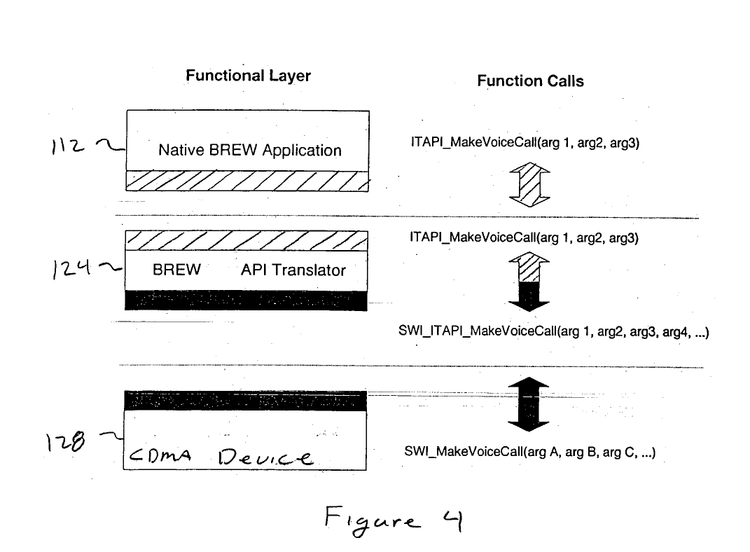

For example, referring to FIG. 4, the native brew application 112 may make a function call. The function call is received by the BREW API translator 124 which then calls the equivalent function call from its API DLL (dynamic linked library). The result will be a message or command response sent to the CDMA device 128. Additionally the process can be reversed. For instance a command/response from the CDMA device 128 is processed by the API DLL of the BREW API translator 124 into the corresponding function call for the BREW application 112.

By utilizing the BREW API translation layer 124, mobile wireless users are no longer restricted to running applications on handsets with limited text entry and minimal graphics and display capabilities. Instead, users and application developers will be able to leverage the multi-media capabilities of PDA's and portable computers. Furthermore, with the ability to use extended applications, BREW is extended to other wireless technologies such as GPRS and UMTS.

As for an implementation, the varieties are numerous. In one embodiment, the portions are implemented as software residing in a memory and accessible to an operating system and to the host processor. Or, in another implementation, the portions can be implemented in progammable or non-programmable hardware. Or, any combination of hardware or software may be implemented.

The steps of the method may be stored or performed from various medium readable by the host device. This may take the form of portable media, such as a floppy disk, CD-ROM, DVD-ROM, or any manner or optical or magnetic media. Or, the specific instructions may be stored in a semiconductor memory.

Thus, the particular combination of parts described and illustrated herein is intended to represent only a certain embodiment of the present invention, and is not intended to serve as a limitation of alternative devices within the spirit and scope of the invention.

1. A method of running at least one application created for a wireless host platform for a wireless device on a host device having a prescribed operating system, the method comprising the steps of:
running an application translator on the host device;
running the application on the host device translating commands from the application with the translator so that the commands can be processed by the host device; and
communicating the commands to the host device wherein the commands initiate specific functions of the wireless device.

2. An apparatus for running at least one application created for a wireless host platform for a wireless device on a host device having a prescribed operating system, the method comprising the steps of:
means for running an application translator on the host device;
means for running the application on the host device translating commands from the application with the translator so that the commands can be processed by the host device; and
means for communicating the commands to the host device wherein the commands initiate specific functions of the wireless device.

3. A computing device, the computing device comprising:
a processing circuitry for executing instructions;
a memory, coupled to the processing circuitry, for storing data;
an operating system;
a wireless device, coupled to the processing circuitry;
an first application operable on the wireless device;
a translation circuitry, coupled to the operating system, that translates commands from the first application with the translator so that the commands can be processed by the processing circuitry; and
a communication circuitry, coupled to the operating system, for communicating the commands to the processor wherein the commands initiate specific functions of the wireless device.

4. The computing device of claim 3 wherein the translation circuitry is a microprocessor.

5. The computing device of claim 3 wherein the communication circuitry is a microprocessor.

6. An electronically readable storage medium readable by a host computing device, the host computing device comprising a control circuitry for executing instructions, and an operating system, the storage medium comprising:
instructions for execution on the processor, the instructions operable to execute a method of running at least one application created for a wireless host platform for a wireless device on the host computing device, the method comprising the steps of:
instructions for running an application translator on the host device;
instructions for running the application on the host device translating commands from the application with the translator so that the commands can be processed by the host device; and
instructions for communicating the commands to the host device wherein the commands initiate specific functions of the wireless device.

7. An application interface for applications to be run on a wireless device connected to a host device, the application interface comprising a module run on the host device and operative to translate application specific commands to the wireless device.
